(19) United States
(12) Patent Application Publication
(10) Pub. No.: US 2025/0267350 A1
(43) Pub. Date: Aug. 21, 2025

(54) A METHOD AND A SYSTEM FOR 3D SURFACE IMAGING

(71) Applicant: INSTITUT NATIONAL DE LA RECHERCHE SCIENTIFIQUE, Quebec (CA)

(72) Inventors: Jinyang LIANG, Boucherville (CA); Cheng JIANG, Montreal (CA); Patrick KILCULLEN, Montréal (CA)

(21) Appl. No.: 18/857,077

(22) PCT Filed: May 11, 2023
(86) PCT No.: PCT/CA2023/050646

§ 371 Date: Oct. 15, 2024

Related U.S. Application Data
(60) Provisional application No. 63/364,507, filed on May 11, 2022.

(51) Int. Cl. H04N 23/56; G06T 7/80

(52) U.S. Cl. CPC H04N 23/56; G06T 7/80; G06T 2207/10152; G06T 2207/30196

(57) ABSTRACT

A system and a method for 3D surface imaging of a 3D object, the method comprising directing a light beam to a digital micromirror device that displays binary fringe patterns, converting the binary fringe patterns to grayscale fringe patterns at an intermediate image plane; rotating the grayscale fringe patterns onto the intermediate image plane to match an aspect ratio of the object, projecting the greyscale fringe patterns from the intermediate image plane to the object, capturing deformed structure images reflected by the object; and transferring the captured images to a computer connected to a frame grabber.

### FIELD OF THE INVENTION

The present disclosure relates to 3D surface imaging. More specifically, the present disclosure is concerned with a method and a system for 3D surface imaging at video rate.

### BACKGROUND OF THE INVENTION

Three-dimensional (3D) surface imaging methods have found a range of applications, including industrial manufacturing, archaeological inspection, entertainment, and biomedicine. The incessant demands of higher accuracy in extracting surface spatial information in complex scenes pose strict requirements to existing 3D imaging methods. For example, a millimeter-level spatial resolution is desired in reliable 3D facial recognition for attendance checks. Meanwhile, video-rate 3D imaging is necessary for fluid-flag interaction analysis in applied bionics. Moreover, spatially isolated 3D objects with large depth discontinuities must be identified for in-situ monitoring and robotic classification. Furthermore, a high dynamic range is indispensable to measure highly reflective objects in defect inspection of steel castings for the automobile industry. Finally, a large field of view (FOV), ideally covering the full human body, is needed to detect and collect 3D movements for virtual reality gaming.

Among existing methods, phase-shifting fringe projection profilometry (PSFPP) has proven to be a potent method for 3D surface imaging. In the most widely used configuration, PSFPP works by first projecting sets of phase-shifting sinusoidal fringe patterns onto 3D objects and then analyzing deformed structure images reflected from the objects to retrieve 3D surface information. In contrast to other structured-light 3D imaging methods, PSFPP uses sinusoidal fringe patterns to encode grayscale phase values for each pixel, followed by phase unwrapping to extract 3D information with a high depth resolution.

The speed of sinusoidal fringe projection is of upmost importance in phase-shifting fringe projection profilometry (PSFPP). Fringe patterns are typically generated by digital micromirror devices (DMDs). Though being a binary amplitude spatial light modulator, a digital micromirror device (DMD) may generate grayscale sinusoids in various ways. The conventional dithering method forms a grayscale image by controlling the average reflectance of each micromirror over time, which clamps the projection rate at hundreds of hertz. To improve the fringe projection speed, binary defocusing methods and band-limited illumination profilometry (BLIP) have been developed, both of which may produce a grayscale sinusoidal pattern from a single binary digital micromirror device mask. Their fringe pattern projection speeds may keep up with the refreshing rate of the digital micromirror device, up to tens of kilohertz (kHz), showing promise for high-speed 3D visualizations.

Dynamic three-dimensional (3D) surface imaging by phase-shifting fringe projection profilometry has been widely implemented in a range of applications. However, existing methods fall short in simultaneously providing the robustness in solving spatially isolated 3D objects, the tolerance of large variation in surface reflectance, and the flexibility of tunable working distances with meter-square-level fields of view (FOVs) at video rate.

There is still a need in the art for a method and a system for 3D surface imaging.

### SUMMARY OF THE INVENTION

More specifically, in accordance with the present invention, there is provided a system for 3D surface imaging of a 3D object, comprising a light source; a digital micromirror device; a band-limited 4f imaging system; a dove prism; a camera lens; and a high-speed camera; wherein a light beam generated by the light source is directed to the digital micromirror device, the digital micromirror device displays binary fringe patterns, the band-limited 4f imaging system converts the binary fringe patterns to grayscale fringe patterns at an intermediate image plane; the dove prism rotates the grayscale fringe patterns onto the intermediate image plane to match an aspect ratio of the object, the camera lens projects the greyscale fringe patterns from the intermediate image plane to the object, and the high-speed camera captures deformed structure images reflected by the object; the captured images being transferred to a computer connected to a frame grabber.

There is further provided a method for 3D surface imaging of a 3D object, comprising directing a light beam to a digital micromirror device, the digital micromirror device displaying binary fringe patterns, converting the binary fringe patterns to grayscale fringe patterns at an intermediate image plane; rotating the grayscale fringe patterns onto the intermediate image plane to match an aspect ratio of the object, projecting the greyscale fringe patterns from the intermediate image plane to the object, capturing deformed structure images reflected by the object by a high-speed camera; and transferring the captured images to a computer connected to a frame grabber.

Other objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

### In the Appended Drawings:

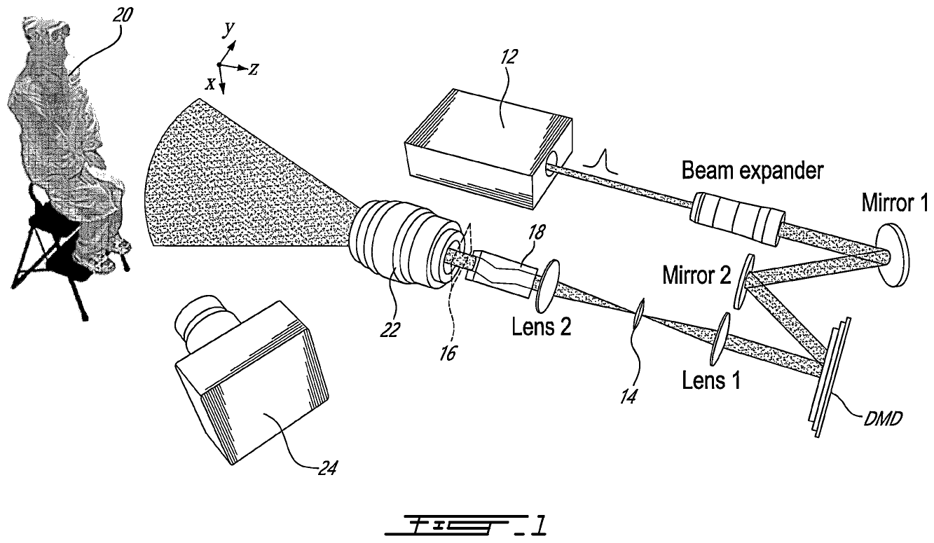

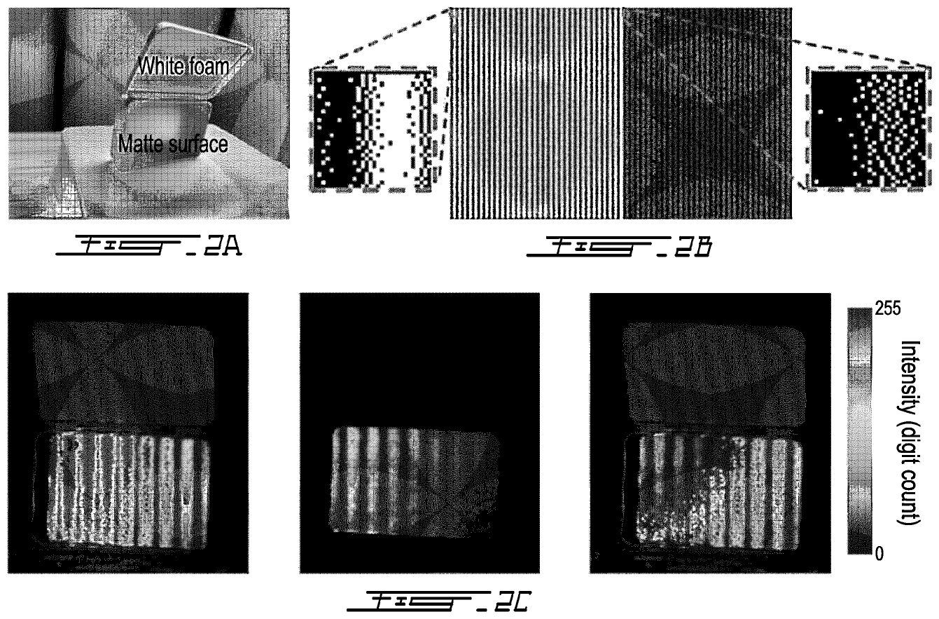

FIG. 1 is a schematic view of a system according to an embodiment of an aspect of the present disclosure;

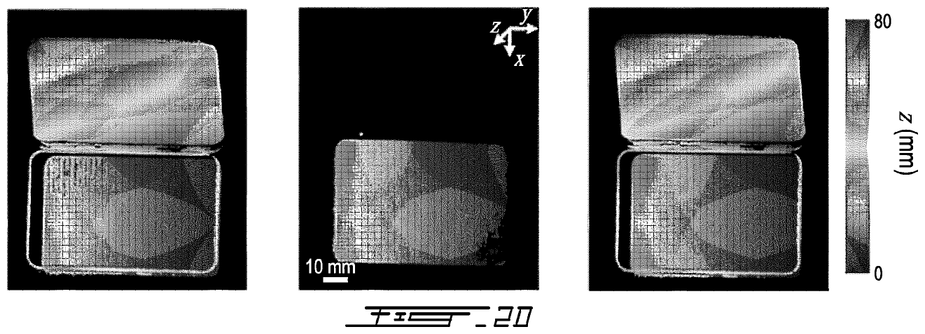

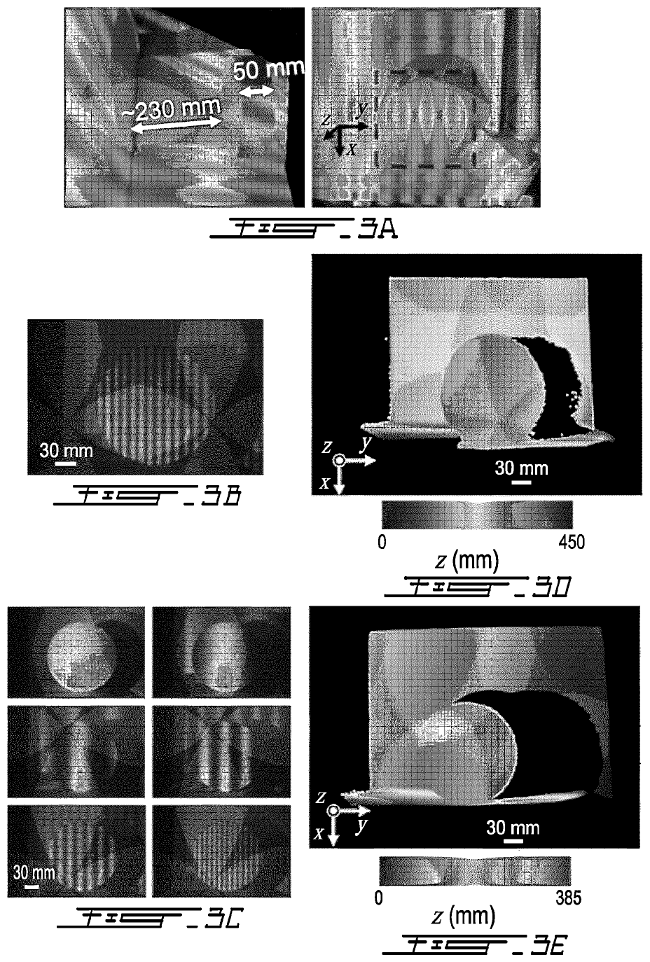

FIG. 2A shows a 3D object with varying reflectance;

FIG. 2B shows representative binary fringe masks with the normalized intensity levels of 1.0 (left) and 0.3 (right), dashed boxes showing close-up views;

FIG. 2C shows representatives fringe images by using high-intensity projection (left), low-intensity projection (middle), and their combination (right);

FIG. 2D shows the 3D reconstruction results in the three cases: high-intensity projection (left), low-intensity projection (middle), and their combination (right);

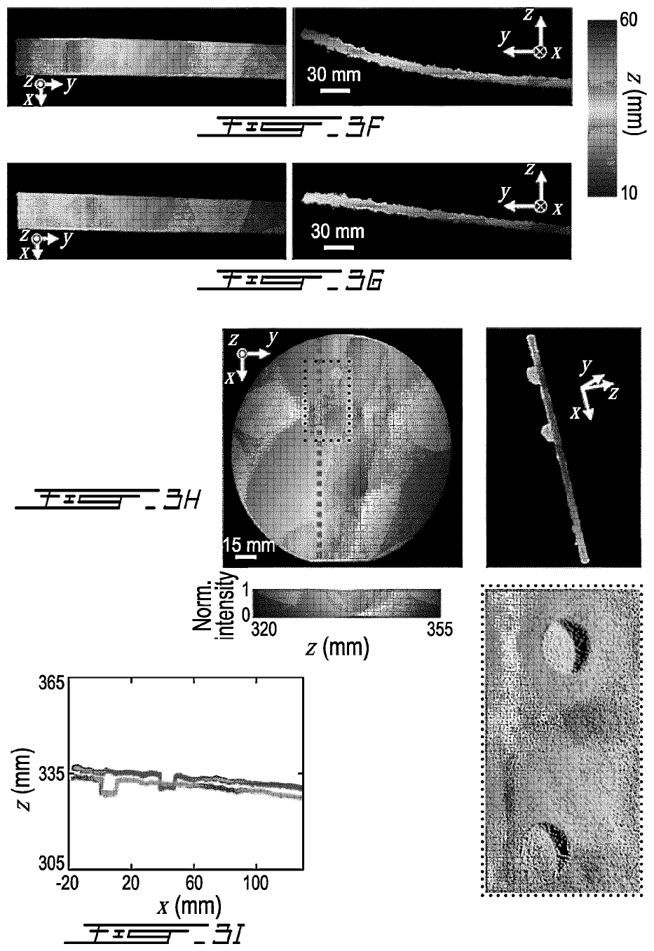

FIG. 3A shows side view (left) and front view (right) of 3D objects with depth discontinuity;

FIG. 3B shows representative deformed structure image by using single-frequency fringe projection;

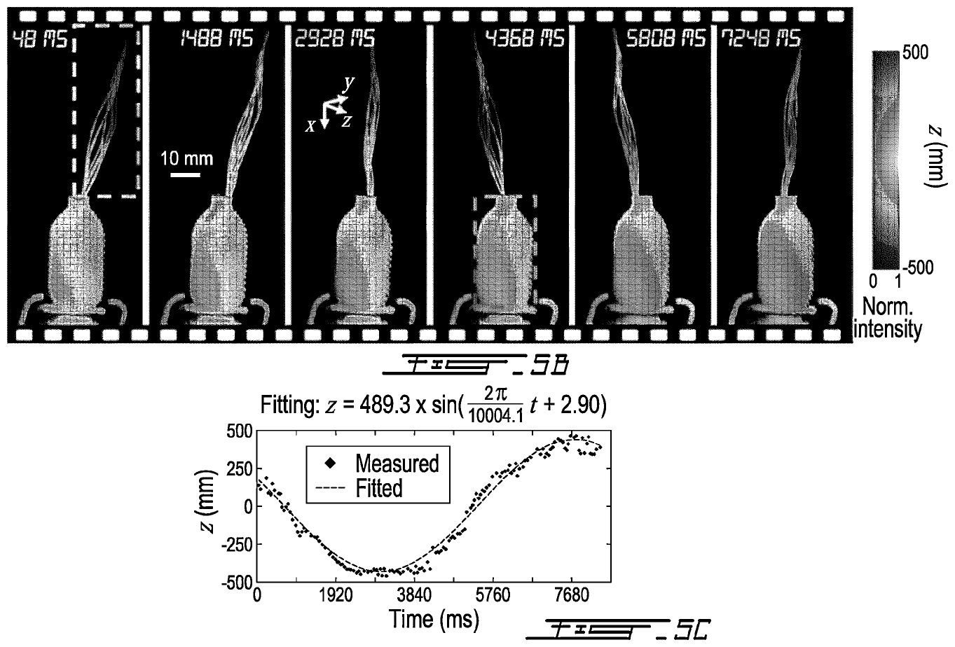

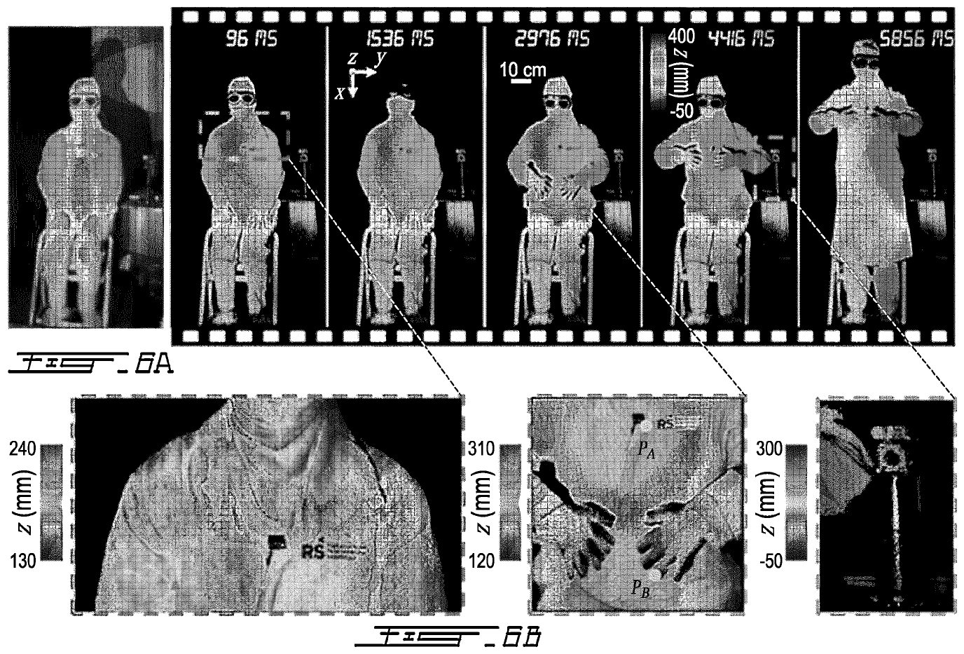

FIG. 3C shows, as in FIG. 38, but using multi-frequency fringe projection;

FIG. 3D shows representative 3D reconstruction from single-frequency;

FIG. 3E shows representative 3D reconstruction from multi-frequency;

FIG. 3F shows 3D reconstruction without distortion compensation of a selected region on the foam plate, indicated by the top dashed box in FIG. 3A; front view (left) and side view (right) are displayed;

FIG. 3G shows 3D reconstruction with distortion compensation of a selected region on the foam plate, indicated by the top dashed box in FIG. 3A; front view (left) and side view (right) are displayed;

FIG. 3H shows front view (left) and side view (right) of the reconstructed flat round surface, indicated as the bottom dashed box in FIG. 3A, dashed box showing a close-up view of the two dents;

FIG. 3I shows selected depth profiles, marked by the purple and green dashed lines in FIG. 3H;

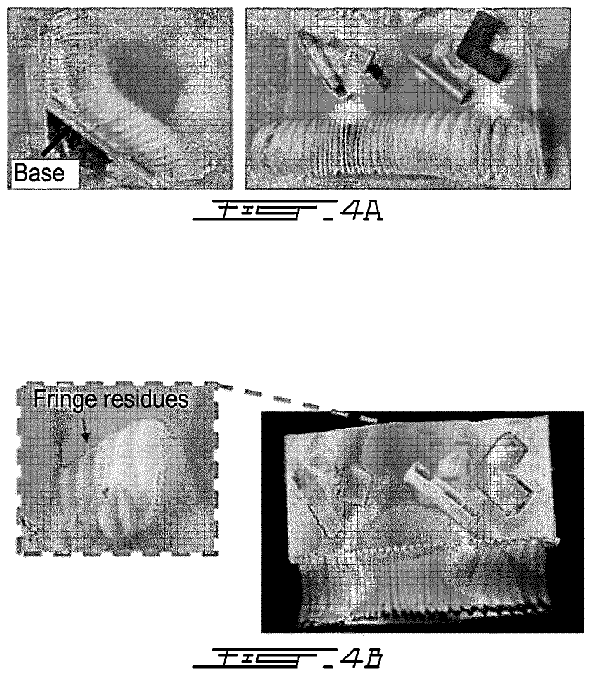

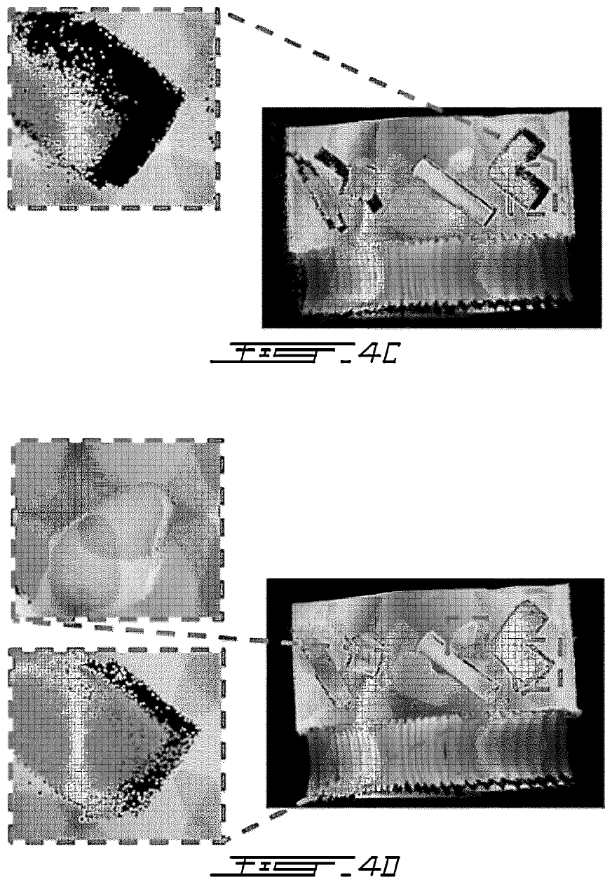

FIG. 4A shows an engineered box;

FIG. 4B shows reconstructed 3D images with high-intensity projection;

FIG. 4C shows reconstructed 3D images with low-intensity projection;

FIG. 4D shows combination of the images of FIGS. 4B and 4C, with close-up views shown on the left column;

FIG. 4E shows time-lapse 3D images of the translationally moving engineered box;

FIG. 4F shows traces of two points, marked in FIG. 4E, with fitting;

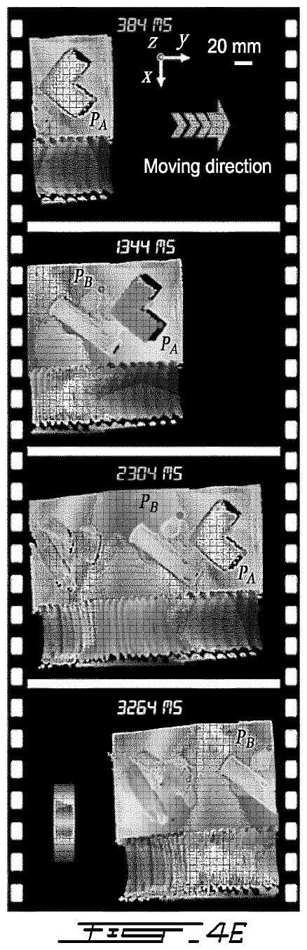

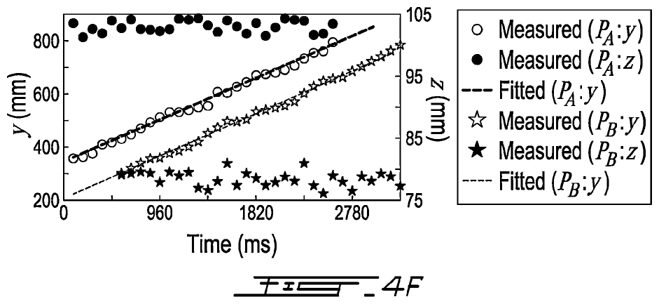

FIG. 5A shows a vase with branches;

FIG. 5B shows time-lapse 3D images of the vase with branches, with close-up views shown in the dashed boxes;

FIG. 5C shows evolution of the depth change of a selected point marked in FIG. 5A with sinusoidal fitting;

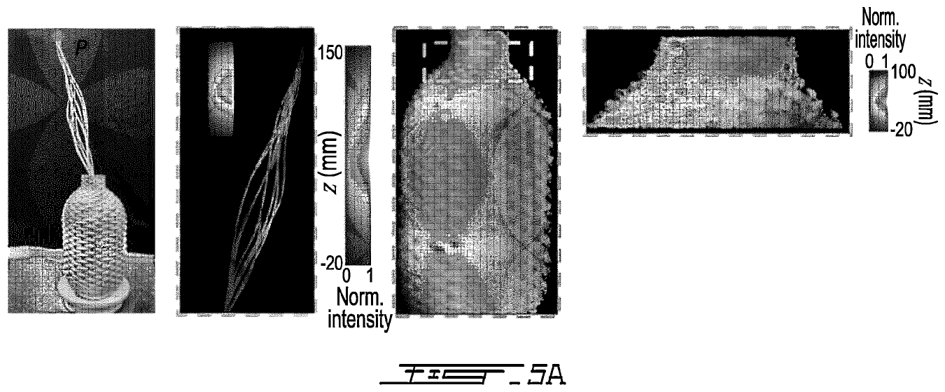

FIG. 6A shows a full human-body;

FIG. 6B shows five time-lapse reconstructed 3D images, with close-up views shown in the dashed boxes; and

FIG. 6C shows evolution of the 3D positions of the selected points marked in the middle close-up view of FIG. 6B.

### DESCRIPTION OF ILLUSTRATIVE EMBODIMENTS

The present invention is illustrated in further details by the following non-limiting examples.

The schematic of a system according to an embodiment of an aspect of the present disclosure is shown in FIG. 1. A pulsed laser 12 is selected, with an average power of 400 mW, a repetition rate of 20 kHz, and a wavelength of 559 nm (for example AONano 559-0.2-10, Advanced Optowave) is used as the light source. After expansion and collimation, the laser beam is directed to a 0.45° digital micromirror device (DMD) (for example AJD-4500, Ajile Light Industries) at an incident angle of about 24° to its surface normal. Binary fringe masks, generated by an error diffusion algorithm from their corresponding grayscale patterns, are loaded onto the digital micromirror device (DMD) and displayed at the DMD display rate, in a range between 500 Hz and 1 kHz. A band-limited 4f imaging system that consists of two lenses (Lens 1 and Lens 2 in FIG. 1; for example AC254-075-A, Thorlabs) and a pinhole 14 (for example P150K, Thorlabs) converts these binary patterns to grayscale fringes at the intermediate image plane 16. The smallest period in the used sinusoidal fringe patterns is 388.8 μm (i.e., 36 DMD pixels), which corresponds to a 150-μm-diameter pinhole 14, as determined, by D=(λf)/p, where λ is the wavelength of the light source; f is the focal length of Lens 1; and p is the period of the sinusoidal fringe patterns used, to pass the spatial frequency components of these patterns while filtering all noise induced by digital halftoning. A dove prism 18 (for example PS992M, Thorlabs), placed between Lens 2 and the intermediate image plane 16, rotates the generated fringe patterns onto the intermediate image plane 16 to match the aspect ratio of the targeted scene, i.e. 3D object 20. Then, a camera lens 22 selected with a focal length smaller than 20 mm, a working distance shorter than 1.5 m and a view angle in a range between 70° and 109° (for example AF-P DX NIKKOR 10-20 mm f/4.5-5.6G VR, Nikon) projects these fringe patterns onto the 3D object 20. Deformed structure images are captured by a high-speed camera selected with a frame rate of at least 1 kHz with an image resolution of at least 1.1 M pixels, such as CMOS camera 24 (for example CP70-1 HS-M-1900, Optronis) with a camera lens (for example AZURE-3520MX5M, AZURE Photonics). Synchronized by the trigger signal of the digital micromirror device (DMD), the acquired images are transferred to a computer (not shown) via a CoaXPress cable (not shown) connected to a frame grabber (for example Cyton-CXP, Bitflow) (not shown).

The light source 12, the digital micromirror device (DMD), the 4f imaging system and the pinhole 14, the intermediate imaging plane 16 and the camera lens 22 may be considered as a projector of the system. A pinhole model is used to modelize the projective behaviors of the camera 24 and the projector with the consideration of image distortion. For a 3D point (x,y,z) in the world coordinate system, in a perfect imaging condition, the pinhole model describes its corresponding pixel on the camera sensor, (u,v), as follows:

$$s [ \begin{matrix}\hat{u} \\ \hat{v} \\ 1\end{matrix} ] = A [ R T ] [ \begin{matrix}x \\ y \\ z \\ 1\end{matrix} ] = [ \begin{matrix}{f}_{u} & 0 & {u}_{pp} \\ 0 & {f}_{v} & {v}_{pp} \\ 0 & 0 & 1\end{matrix} ] [ R T ] [ \begin{matrix}x \\ y \\ z \\ 1\end{matrix} ] \qquad ( 1 )$$

The matrix A contains the intrinsic parameters of the camera: fᵤ and fᵥ describe the effective focal lengths along the axes of the camera, and (uₚₚ, vₚₚ) is the coordinate of the principal point of the camera. Defined as the extrinsic parameters of the camera, R is a 3×3 matrix accounting for rotation, and T is a 3×1 matrix for translation. s is a scalar factor of numerical extraction of (û, \hat{v}). Overall, this operation is expressed by (û, \hat{v})=Proj_{c}(x,y,z). Similarly, the projection of the 3D point to the projector is modeled by (û″, \hat{v}″)=Projₚ(x,y,z). The superscript of double prime is used hereafter to refer to the coordinates for the projector.

To take into consideration of distortion in the acquisition of deformed structure images, the normalized camera coordinate without distortion are first defined as follows:

$$[ \begin{matrix}{\hat{u}}_{n} \\ {\hat{v}}_{n}\end{matrix} ] = [ \begin{matrix}( \hat{u} - {u}_{pp} ) / {f}_{u} \\ ( \hat{v} - {v}_{pp} ) / {f}_{v}\end{matrix} ] \qquad ( 2 )$$

Then, the distorted normalized camera coordinate (uₙ, vₙ) is determined as follows:

$$[ \begin{matrix}{u}_{n} \\ {v}_{n}\end{matrix} ] = ( 1 + {d}_{1} {\hat{r}}_{n}^{2} + {d}_{2} {\hat{r}}_{n}^{4} + {d}_{3} {\hat{r}}_{n}^{6} ) [ \begin{matrix}{\hat{u}}_{n} \\ {\hat{v}}_{n}\end{matrix} ] + [ \begin{matrix}2 {d}_{4} {\hat{u}}_{n} {\hat{v}}_{n} + {d}_{5} ( {\hat{r}}_{n}^{2} + \hat{2} {u}_{n}^{2} ) \\ 2 {d}_{5} {\hat{u}}_{n} {\hat{v}}_{n} + {d}_{4} ( {\hat{r}}_{n}^{2} + \hat{2} {u}_{n}^{2} )\end{matrix} ] \qquad ( 3 )$$

d₁, . . . , dₛ are the camera system distortion coefficients, and \hat{r}ₙ²=ûₙ²+\hat{v}ₙ². Once (uₙ, vₙ) is computed, the distorted camera pixel coordinate (u,v) is obtained by using Relation (2). Overall, this operation is expressed as (u,v)=Dist_{c}(û, \hat{v}). Similarly, the distortion for the projector is modeled by (u″, v″)=Distₚ(û″, \hat{v}″).

Calibration of the system is performed to compute the intrinsic parameters, extrinsic parameters, and image distortion coefficients for both the camera and the projector. For calibration of the camera, a checkerboard pattern is imaged with 20-40 poses. A MATLAB toolbox was used to extract the grid corners, which allowed calculating all the calibration parameters. For calibration of the projector, the projector is treated as another camera to adopt the similar process used for the camera calibration. The method involved capturing additional images of the checkerboard pattern under the illumination of both horizontally and vertically shifted fringe patterns to determine the pixel-wise mapping between the camera view and the projector view. Then, the camera-captured images of the checkerboard were transformed to generate the corresponding images from the perspective of the projector. Finally, the same MATLAB toolbox used for the camera calibration was implemented to compute the corresponding calibration parameters of the projector.

To image 3D objects with a large range of reflectance, dual-level intensity projection for projection intensity modulation is used to improve the dynamic range. In experiments, two normalized intensity levels, empirically selected to be 1.0 and 0.3, are set for each fringe pattern. For any camera pixel in the acquired deformed structure images, if any values in the sequence of high-intensity projection are saturated, then it is replaced with the corresponding sequence with low intensity (FIGS. 2 and 3A-3D).

To robustly reconstruct spatially isolated object, coordinate recovery is performed using multi-frequency fringe projection. Multiple sets of fringe patterns with different periods are projected to the 3D objects, and the phase unwrapping is conducted as a hierarchical manner (FIGS. 3B-3E). More precisely, the intensity of the camera pixel (u,v) in the captured deformed structure images may be expressed as follows:

$${I}_{km} ( u , v ) = {I}_{b} ( u , v ) + {I}_{va} ( u , v ) cos [ {φ}_{m} ( u , v ) - 2 π k / K ] \qquad ( 4 )$$

Iₖₘ(u,v) represents the intensity in the kth deformed structure image in the m^{th} sequence. K is the number of phase-shifting steps. In the present disclosure, four-step phase shifting in six sets of fringes is used, so that K=4, k∈[0,3], and m∈[0,5]. I_{b}(u,v), Iᵥₐ(u,v), and φₘ(u,v) represent the background, intensity variation, and depth-dependent phase for the m^{th} sequence, respectively. From Relation (4), the calculated φₘ(u,v) is wrapped in the interval (−π, π]. Then, phase unwrapping is performed to determine the horizontal coordinate of the projector, which is then used to solve the 3D surface information by triangulation.

In single-frequency fringe projection, a single unwrapped phase map is generated by a two-dimensional weighted phase unwrapping algorithm, which must make assumptions about the surface smoothness. The unwrapped phase value of each pixel is derived according to the phase values within a local neighborhood of this pixel. Consequently, this method falls short in solving the phase ambiguities induced by the depth-discontinued regions or isolated objects.

This limitation is lifted by multi-frequency fringe projection that unwraps the phase value of each pixel individually. The values of Pₚ^{m} in the present disclosure were determined by synthetically considering the signal-to-noise ratios and the measurement accuracy of the system. The coarsest fringe pattern is selected to have no more than one period so that its absolute phase, defined as \tilde{φ}₀(u,v), equals the wrapped phase map φ₀(u,v). The ensuing sets of fringe patterns, i.e., m>0, have the periods of Pₚ^{m}=Round(Nᵤ/2^{m}). Here, Nᵤ is the width of the DMD expressed in the unit of DMD pixel. Because unwrapped phase maps of two adjacent sets of fringe projection have the relationship of \tilde{φ}ₘ(u,v)=(Pₚ^{m-1}/Pₚ^{m})\tilde{φ}ₘ₋₁(u,v), the absolute phase map for m>0 may be calculated as follows:

$${\tilde{φ}}_{m} ( u , v ) = {φ}_{m} ( u , v ) + 2 π \cdot Round [ \frac{{( {P}_{p}^{m - 1} / {P}_{p}^{m} )}_{{\tilde{φ}}_{m - 1} ( u , v ) - {φ}_{m} ( u , v )}}{2 π} ] \qquad ( 5 )$$

Relation (5) shows that, unlike single-frequency phase unwrapping, the phase of each pixel is unwrapped independently, which avoids incorrect depth quantification in analyzing spatially isolated objects. Using this method, the unwrapped phase map of each set of fringe patterns is computed successively, and \tilde{φ}₅(u,v) is used to compute the horizontal coordinate of the projector, denoted by u″, as follows:

$${u}^{″} = {\tilde{φ}}_{5} ( u , v ) \frac{{P}_{p}^{5}}{2 π} + \frac{1}{2} ( {N}_{u} - 1 ) \qquad ( 6 )$$

Distortion compensation contains two major steps. First, the undistorted camera pixel coordinate (û, \hat{v}) is extracted by performing the inverse operation of the distortion model (i.e., Dist_{c}). However, the direct inversion of Relation (3) takes the form of a 7^{th} degree polynomial in both ûₙ and \hat{v}ₙ, rendering direct recovery difficult. Thus, a fixed-point iteration method is applied for computing the undistorted normalized camera coordinate (ûₙ, \hat{v}ₙ). With the initial condition of

$$[ \begin{matrix}{\hat{u}}_{n , 0} \\ {\hat{v}}_{n , 0}\end{matrix} ] = [ \begin{matrix}( u - {u}_{pp} ) / {f}_{u} \\ ( v - {v}_{pp} ) / {f}_{v}\end{matrix} ] ,$$

the i^{th} iteration is described as follows:

$$[ \begin{matrix}{\hat{u}}_{n , i + 1} \\ {\hat{v}}_{n , i + 1}\end{matrix} ] = \frac{[ \begin{matrix}{\hat{u}}_{n , i} \\ {\hat{v}}_{n , i}\end{matrix} ] - [ \begin{matrix}2 {d}_{4} {\hat{u}}_{n , i} {\hat{v}}_{n , i} + {d}_{5} ( {\hat{r}}_{n , i}^{2} + 2 {\hat{u}}_{n , i}^{2} ) \\ 2 {d}_{5} {\hat{u}}_{n , i} {\hat{v}}_{n , i} + {d}_{4} ( {\hat{r}}_{n , i}^{2} + 2 {\hat{v}}_{n , i}^{2} )\end{matrix} ]}{1 + {d}_{1} {\hat{r}}_{n , i}^{2} + {d}_{2} {\hat{r}}_{n , i}^{4} + {d}_{3} {\hat{r}}_{n , i}^{6}} \qquad ( 7 )$$

where \hat{r}_{n,i}²=û_{n,i}²+\hat{v}_{n,i}². The corresponding undistorted pixel coordinate (û, \hat{v}) on the camera plane is then calculated by using Relation (2). Overall, this operation is expressed as (û, \hat{v})=DistComp_{c}(u,v).

The next step is to obtain the corresponding undistorted projector horizontal pixel coordinate u″. In Relation (1),

$$A [ R T ] = [ \begin{matrix}{a}_{11} & … & {a}_{14} \\ ⋮ & ⋱ & ⋮ \\ {a}_{31} & … & {a}_{34}\end{matrix} ] and {A}^{″} [ {R}^{″} {T}^{″} ] = [ \begin{matrix}{b}_{11} & … & {b}_{14} \\ ⋮ & ⋱ & ⋮ \\ {b}_{31} & … & {b}_{34}\end{matrix} ] .$$

By using Proj_{c} and Projₚ, the coordinate of the distortion-compensated 3D point is calculated by triangulation as follows:

$$[ \begin{matrix}x \\ y \\ z\end{matrix} ] = Tri ( \hat{u} , \hat{v} , {\hat{u}}^{″} ) = {[ \begin{matrix}{a}_{11} - \hat{u} {a}_{31} & {a}_{12} - \hat{u} {a}_{32} & {a}_{13} - \hat{u} {a}_{33} \\ {a}_{21} - \hat{v} {a}_{31} & {a}_{22} - \hat{v} {a}_{32} & {a}_{23} - \hat{v} {a}_{33} \\ {b}_{11} - {\hat{u}}^{″} {b}_{31} & {b}_{12} - {\hat{u}}^{″} {b}_{32} & {b}_{13} - {\hat{u}}^{″} {b}_{33}\end{matrix} ]}^{- 1} [ \begin{matrix}\hat{u} {a}_{34} - {a}_{14} \\ \hat{v} {a}_{34} - {a}_{24} \\ {\hat{u}}^{″} {b}_{34} - {b}_{14}\end{matrix} ] \qquad ( 8 )$$

Ideally, û″ is computed by (û″, \hat{v}″)=DistCompₚ(u″, v″). However, v″ cannot be calculated from the projection of vertical fringe patterns. To overcome this limitation, an iterative method is developed to recover distortion-compensated 3D information without prior knowledge of v″ from fringe measurements. First, the coordinate of the 3D point is estimated by the Tri function (see relation (8)) by using the coordinate (û, \hat{v}, u″). This 3D point is then projected to the projector plane to extract the initial estimate of v″ with the function of Distₚ, which is input to an iterative algorithm. Each iteration starts with performing the function DistCompₚ by using u″ calculated from Relation (6) and the variable v″ to compute the distortion compensated projector coordinate u″, which is then used to extract the 3D coordinate by the function Tri. The method is presented as the following pseudo-code:

$${u}^{″} = {\tilde{φ}}_{5} ( u , v ) \frac{{P}_{p}^{5}}{2 π} + \frac{1}{2} ( {N}_{u} - 1 ) \qquad ( 6 )$$

To obtain the system distortion coefficients from the calibration procedure, and analyze the undistorted pixel matching, the method further comprises iterative distortion compensation in 3D point recovery (FIGS. 3F, 3G). Distortion compensation contains two major steps. First, the undistorted camera pixel coordinate (û, \hat{v}) is extracted by performing the inverse operation of the distortion model (i.e., Dist_{c}). However, the direct inversion of Relation (3) takes the form of a 7^{th} degree polynomial in both ûₙ and \hat{v}ₙ, rendering direct recovery difficult. Thus, a fixed-point iteration method is applied for computing the undistorted normalized camera coordinate (ûₙ, \hat{v}ₙ). With the initial condition of

$$[ \begin{matrix}{\hat{u}}_{n , 0} \\ {\hat{v}}_{n , 0}\end{matrix} ] = [ \begin{matrix}( u - {u}_{pp} ) / {f}_{u} \\ ( v - {v}_{pp} ) / {f}_{v}\end{matrix} ] ,$$

the i^{th} iteration is described as follows:

$$[ \begin{matrix}{\hat{u}}_{n , i + 1} \\ {\hat{v}}_{n , i + 1}\end{matrix} ] = \frac{[ \begin{matrix}{\hat{u}}_{n , i} \\ {\hat{v}}_{n , i}\end{matrix} ] - [ \begin{matrix}2 {d}_{4} {\hat{u}}_{n , i} {\hat{v}}_{n , i} + {d}_{5} ( {\hat{r}}_{n , i}^{2} + 2 {\hat{u}}_{n , i}^{2} ) \\ 2 {d}_{5} {\hat{u}}_{n , i} {\hat{v}}_{n , i} + {d}_{4} ( {\hat{r}}_{n , i}^{2} + 2 {\hat{v}}_{n , i}^{2} )\end{matrix} ]}{1 + {d}_{1} {\hat{r}}_{n , i}^{2} + {d}_{2} {\hat{r}}_{n , i}^{4} + {d}_{3} {\hat{r}}_{n , i}^{6}} \qquad ( 7 )$$

where \hat{r}_{n,i}²=û_{n,i}²+\hat{v}_{n,i}². The corresponding undistorted pixel coordinate (û, \hat{v}) on the camera plane is then calculated by using Relation (2). Overall, this operation is expressed as (û, \hat{v})=DistComp_{c}(u,v).

The next step is to obtain the corresponding undistorted projector horizontal pixel coordinate u″. In Relation (1),

$$A [ R T ] = [ \begin{matrix}{a}_{11} & … & {a}_{14} \\ ⋮ & ⋱ & ⋮ \\ {a}_{31} & … & {a}_{34}\end{matrix} ] and {A}^{″} [ {R}^{″} {T}^{″} ] = [ \begin{matrix}{b}_{11} & … & {b}_{14} \\ ⋮ & ⋱ & ⋮ \\ {b}_{31} & … & {b}_{34}\end{matrix} ] .$$

By using Proj_{c} and Projₚ, the coordinate of the distortion-compensated 3D point is calculated by triangulation as follows:

$$[ \begin{matrix}x \\ y \\ z\end{matrix} ] = Tri ( \hat{u} , \hat{v} , {\hat{u}}^{″} ) = {[ \begin{matrix}{a}_{11} - \hat{u} {a}_{31} & {a}_{12} - \hat{u} {a}_{32} & {a}_{13} - \hat{u} {a}_{33} \\ {a}_{21} - \hat{v} {a}_{31} & {a}_{22} - \hat{v} {a}_{32} & {a}_{23} - \hat{v} {a}_{33} \\ {b}_{11} - {\hat{u}}^{″} {b}_{31} & {b}_{12} - {\hat{u}}^{″} {b}_{32} & {b}_{13} - {\hat{u}}^{″} {b}_{33}\end{matrix} ]}^{- 1} [ \begin{matrix}\hat{u} {a}_{34} - {a}_{14} \\ \hat{v} {a}_{34} - {a}_{24} \\ {\hat{u}}^{″} {b}_{34} - {b}_{14}\end{matrix} ] \qquad ( 8 )$$

Ideally, u″ is computed by (û″, \hat{v}″)=DistCompₚ(u″, v″). However, v″ cannot be calculated from the projection of vertical fringe patterns. To overcome this limitation, an iterative method is developed to recover distortion-compensated 3D information without prior knowledge of v″ from fringe measurements. The coordinate of the 3D point is first estimated by the Tri function (see Relation. (8)) by using the coordinate (û, \hat{v}, û″). This 3D point is then projected to the projector plane to extract the initial estimate of v″ with the function of Distₚ, which is input to an iterative algorithm. Each iteration starts with performing the function DistCompₚ by using u″ calculated from Relation (6) and the variable v″ to compute the distortion compensated projector coordinate u″, which is then used to extract the 3D coordinate by the function Tri. The method is presented as the following pseudo-code:

Algorithm to recover 3D information with distortion compensation

| | Input: (û,\hat{v},u″), maximum iterations N, vertical projector pixel error tolerance | |
|---|---|---|
| | TOL, calibration parameters of camera: A, R, T, s, d₁, d₂, d₃, d₄, d₅; | |
| | calibration parameters of projector: A″, R″, T″, s″, d₁″, d₂″, d₃″, d₄″, d₅″ | |
| | Output: (x,y,z) | |
| | Variables: q, h₁, h₂, h₃, h₄, v_{q}″, û″ | |
| 1 | Set q = 1 | |
| 2 | compute (x,y,z) = Tri(û,\hat{v},u″) | |
| 3 | compute (h₁, h₂) = Projₚ(x,y,z) | |
| 4 | compute (about ,v_{q}″) = Distₚ(h₁, h₂) | |
| 5 | while (q ≤ N) do steps 6 - 11 | |
| 6 | | \| compute (û″,about) = DistCompₚ (u″,v_{q}″) |
| 7 | | \| compute (x,y,z) = Tri(û,\hat{v},û″) |
| 8 | | \| compute (h₃, h₄) = Projₚ(x,y,z) |
| 9 | | \| compute (about ,v_{q+1}″) = Distₚ(h₃, h₄) |
| 10 | | \| if \|v_{q+1}″ − v_{q}″\| ≤ TOL, go to step 13 |
| 11 | | \| Set q = q + 1 |

| | |
|---|---|
| 12 | End |
| 13 | Output (x,y,z) |
| 14 | End |

To verify the feasibility of the method and system, static 3D objects were imaged at a working distance of 0.5 m, with an FOV of 0.3 m×0.2 m. The depth resolution, quantified by the standard deviation of a reconstructed planar surface, was measured to be 0.3 mm. The lateral resolution, quantified by imaging the sharp edge of the planar surface, was 0.4 mm.

To demonstrate ability of the method and system to tolerate a large range of reflectance, an open box that had a highly reflective matte surface with a weakly reflective foam surface was imaged (FIG. 2A). The representative fringe masks with two intensity levels are displayed in FIG. 2B. The effect of different intensity levels in deformed structure images is compared in FIG. 2C. The high-intensity projection (i.e., Iₖₘ^{1.0}) results in a large number of saturated pixels in the left region of the matte surface. The low-intensity projection (i.e., Iₖₘ^{0.3}), despite eliminating saturation, fails to resolve the white foam surface and the right bottom part of the matte surface. The dynamic ranges of Iₖₘ^{1.0} and Iₖₘ^{0.3} were calculated to be 48.1 dB and 41.8 dB, respectively. In comparison, dual-level intensity projection preserves low-intensity pixels while avoiding any saturation (FIG. 2D). With an enhanced dynamic range of 58.6 dB, this method fully recovers this 3D object.

The high accuracy of the multi-scale band-limited illumination profilometry (MS-BLIP) method and system in imaging 3D objects with depth discontinuities is proven by comparing the multi-frequency phase unwrapping method applied in MS-BLIP with the standard single-frequency counterpart. As shown in FIG. 3A, a 50-mm-long cylinder with a 15-cm-diameter flat front surface stands on a base. A square foam plate is placed about 230 mm behind the cylinder. The single-frequency method used four phase-shifting fringe patterns with a period of 36 pixels (i.e., Pₚ⁵) and an additional pattern of the vertical central line of the DMD. FIGS. 3B-3C show the captured deformed structure images by using the two methods. Because the distance between the cylinder and the foam plate resulted in a shift of multiple periods of fringes in deformed structure images, single-frequency fringe projection fails to correctly resolve the depth in the left half of the cylinder (FIG. 3D). In contrast, displayed in FIG. 3E, the multi-frequency method, adopted in MS-BLIP, accurately recovers the detailed 3D information. Specifically, the calculated depth between the front surface of the cylinder to the foam plate is 281.7 mm, which well matches the ground truth, with a deviation of 0.61%.

To demonstrate the necessity of distortion compensation, the 3D reconstruction results of a selected region on the foam plate (dashed box in FIG. 3A) were analyzed. As shown in FIG. 3F, the system distortion mistakenly guides the 3D reconstruction, which displays a curved structure of the reconstructed surface. With the iterative method for distortion compensation applied in MS-BLIP, the surface with correct depth information is presented in FIG. 3G.

MS-BLIP may accurately resolve 3D information of fine structures. FIG. 3H shows the 3D reconstruction of the flat round surface of the cylinder with two dents (dashed box in FIG. 3A). The quantitative analysis of selected line profiles shows that the two dents on the flat surface have a depth of 6.0 mm and a diameter of 10.0 mm (FIG. 3I). The deviations from the ground truth are 0.3 mm and 0.5 mm, respectively, which show an excellent agreement with the configuration of the object.

To highlight the potential application of MS-BLIP in automated detection and classification, an engineered box moving translationally at a speed of about 15 cm/s was imaged (FIG. 4A). The box used a piece of curved cardboard as the base, on which pipes made of different materials were fixed. On the top row, the left pipe was made of black foam with low reflectance, while the other three metal pipes, as well as the white swelling glue, had high reflectance. MS-BLIP had a 3D imaging speed of 10.4 fps, an FOV of 0.3 m×0.2 m at a working distance of 0.5 m, a depth resolution of 1.3 mm, and a lateral resolution of 1.1 mm.

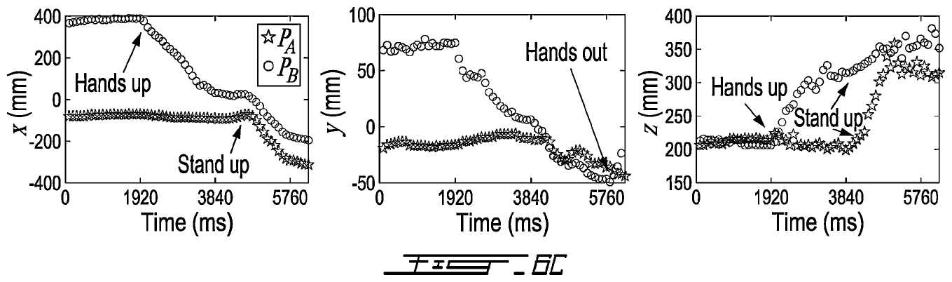

FIGS. 4B-4D show the advantage of dual-level intensity projection. For the Iₖₘ^{1.0} projection, because saturated intensity distorted the pixel-wised sinusoidal intensity profile, fringe residues show up as artifacts on the regions with high reflectance (FIG. 48). Meanwhile, due to the lack of scattered light intensity from the Iₖₘ^{0.3} projection, part of the black foam pipe was failed to be reconstructed (FIG. 4C). In contrast, the dual-level intensity projection enhanced the dynamic range by over 12 dB. Presented in FIG. 4D, the dual-level intensity projection successfully reconstructs the full shape of this 3D object.

FIG. 4E shows the reconstructed 3D images of the moving engineered box at four time-lapse frames with an interval of 960 ms. MS-BLIP allowed tracking the 3D movements of all spatial points. As an example, the time-resolved positions of two points, selected from the pipes with both low and high reflectance (marked by P_{A} and P_{B} in FIG. 4E), are shown in FIG. 4F. The results reveal that the two points have linear movement in the y axis at 15.4 cm/s but stay relatively stationary in the z axis, well matching the pre-set experimental condition.

To demonstrate potential of the MS-BLIP method and system in industrial inspection, the rotational movement of a bamboo vase with extending branches was imaged (FIG. 5A). With a height of 1.3 m, this 3D object was glued on a stand rotating at 0.6 rad/s. To fit the projection region with the desired imaging area, the dove prism was placed at 45°, which results in a 90° rotation of the projected patterns with respect to the fringe masks loaded onto the DMD. MS-BLIP was operated at a working distance of 2 m, with an FOV of 1.5 m×1.0 m, and at a 3D imaging speed of 20.8 fps. Under these working conditions, the depth resolution was quantified to be 3.7 mm, and the lateral resolution was measured to be 1.7 mm.

FIG. 5B shows six time-lapse 3D images of the object. The close-up view of the vase mouth presents detailed structural information on its surface. The depth-encoded color change of the branches reflects the rotation movement of the object. By tracking the 3D position of the tip of the branches (marked by P in FIG. 5A), MS-BLIP reveals its rotational radius of 489.3 mm and the period of 10004.1 ms (FIG. 5C), showing a uniform rotation with the pre-set speed.

To explore the potential of MS-BLIP in human-computer interaction, the full-body movements of a volunteer was imaged. All the experiments were conducted in accordance with the protocol (Project CER-22-649) approved by the human ethics research committee of Institut National de la Recherche Scientifique, Universite du Quebec. A photo of the scene is shown in FIG. 6A. The volunteer had a height of about 1.6 m, wearing proper protective clothing and a laser goggle. Both hands were exposed to the laser illumination with intensity and fluence of 7.8×10⁻⁷ W/cm² and 3.9×10⁻¹¹ J/cm² respectively, which is much lower than the maximum permissible exposure, i.e., 0.2 W/cm² and 2×10⁻² J/cm², regulated by the ANSI safety limit. A part of an optical table on the left of this volunteer was also included in the FOV. Akin to the 3D imaging of rotational movement, the dove prism was set to 45°. The MS-BLIP system was operated with a working distance of 2.8 m and an FOV of 1.7 m×1.1 m. It had a 3D imaging speed of 10.4 fps. The depth and the lateral resolutions were measured to be 4.7 mm and 2.4 mm, respectively.

FIG. 6B shows five time-lapse 3D images of the instantaneous poses of the volunteer. The detailed surface structures of the lab coat and hands of the volunteer are illustrated by the close-up views. The edge of an optical table and optomechanical components may also be seen as a static background. As displayed in FIG. 6C, the 3D positions of two selected points were tracked over time: the ring finger's tip of the volunteer's left hand and the edge point of a marker on the volunteer's coat. In the experiment, the 3D image acquisition began when the volunteer sat on a stepladder with both hands on the knees. Afterward, the volunteer moved up both hands at 2016 ms, resulting in a change of the fingertip position along all three axes (marked by the arrows for “Hands up” in FIG. 6C). The volunteer's body stayed at the same position until 4128 ms when the volunteer stood up, which results in movements along the −x axis for both points) marked by the arrow for “Stand up” in FIG. 6C). In addition, the forward incline movement of the volunteer's body while standing up was also reviewed according to the position changes along the +z axes. At 6048 ms, the volunteer stretched out both hands, which is responsible for the sudden increase of the y value (marked by the arrow for “Hands out” in FIG. 6C).

It is thus shown that MS-BLIP allows for robust multi-scale 3D surface imaging at video rate. In MS-BLIP, dual-level intensity projection is used to tolerate the variation in 3D objects' reflectance. Multi-frequency fringe projection is used to robustly resolve spatially isolated 3D objects with depth discontinuity. Finally, an iterative method for distortion compensation in 3D point recovery is used to improve the quality of reconstruction. Thus, MS-BLIP provides dynamic 3D visualization of translational movements of an engineered box, rotational movements of a craft vase, and full human body movements at an imaging speed of up to 20.8 fps and a measurement volume of up to 1.5 m³, representing a three order of magnitude increase compared to existing BLIP systems and methods. Specifications used for main demonstrations are summarized in Table 1 below.

TABLE 1
Major specifications of MS-BLIP in dynamic 3D imaging experiments

| | | | Projection/ | Camera | 3D | |
|---|---|---|---|---|---|---|
| | Working | (x, y) | acquisition | exposure | imaging | Depth |
| | distance | FOV | speed | time | speed | resolution |
| Application | (m) | (m²) | (Hz) | (ms) | (fps) | (mm) |
| Translating | 0.5 | 0.3 × 0.2 | 500 | 2 | 10.4 | 1.3 |
| engineered | | | | | | |
| box | | | | | | |
| Rotating | 2.0 | 1.0 × 1.5 | 1000 | 1 | 20.8 | 3.7 |
| vase | | | | | | |
| Full human | 2.8 | 1.1 × 1.7 | 500 | 2 | 10.4 | 4.7 |
| body | | | | | | |

MS-BLIP illumination scheme may be readily adapted to other multi-frequency PSFPP systems. Holding a strict imaging relationship between the DMD and the 3D objects, MS-BLIP preserves high accuracy and high contrast of grayscale fringe patterns at different frequencies. Despite being demonstrated in the examples presented in the present disclosure only with six selected frequencies, MS-BLIP may be applied to accommodate varying frequencies, arbitrary sets of patterns, and a range of working distances and FOVs for specific studies. Moreover, by using a nanosecond pulsed laser as the illumination source, since the laser pulse width is much shorter than the display rate of the DMD, no photons are wasted during pattern switching, as opposed to using a continuous-wave laser. This advantage also sheds light on implementing MS-BLIP using high-speed cameras to increase 3D imaging speeds while maintaining signal-to-noise ratios. Also, as dove prism is used to adjust the orientation of the FOV, i.e. to rotate the generated fringe patterns onto the intermediate image plane, the aspect ratio of the projected area is not fixed by the shape of the DMD. Changing the aspect ratio limits the active region of the DMD, which, however, reduces the overall light throughput. The dove prism increases the flexibility in the orientation of the projection region, thereby allowing MS-BLIP to fit a range of applications.

The imaging speed of the MS-BLIP system and method may be controlled by selecting multiple cameras, the display rate of the DMD, and the power of the light source. Moreover, online feedback may be used to adaptively adjust the intensity of projected patterns, to optimize the dynamic range of the MS-BLIP system for different working conditions. Furthermore, to take into account possible measurement inaccuracy induced by laser speckles, a superluminescent diode and a rotating diffuser may be implemented in the MS-BLIP system, and a filtering algorithm in image reconstruction applied. Also, a graphic processing unit may be used to accelerate the computation of phase maps for real-time display of the 3D reconstruction results. Besides technical improvement, further applications of MS-BLIP may be contemplated, including automated industrial inspection, archaeology, and human-computer interaction for example.

There is thus presented a multi-frequency band-limited illumination profilometry method and system for video rate three-dimensional surface imaging. The method comprises creating sinusoidal fringes by binary spatial modulation of a laser light source using a DMD, and subsequent frequency filtering with a pinhole in a 4f setup. Coherent light fringe projection is combined with the adaptation of hierarchical phase unwrapping, thereby allowing to reconstruct spatially separated objects, the recording of fringe images with different exposure times, thereby allowing accounting for large variations of reflectance, and the use of an iterative algorithm enables, to, for distortion compensation, into a fringe generation method allowing surface imaging speed very close to video rate.

The present multi-scale (MS) band-limited illumination profilometry (BLIP) method and system thus provides robust 3D surface imaging at video rate, by implementing multi-frequency fringe projection with the associated phase unwrapping, which enables imaging spatially isolated 3D objects. Meanwhile, MS-BLIP adopts dual-level intensity projection to enhance its dynamic range, which allows recovering 3D information from surfaces with high reflectance. Moreover, MS-BLIP applies an iterative method for distortion compensation, which improves the 3D reconstruction quality over a m²-level FOV. Finally, MS-BLIP is demonstrated for video-rate 3D surface measurements at varying working distances of up to 2.8 m with tunable FOVs of up to 1.7 m×1.1 m.

Multi-scale band-limited illumination profilometry (MS-BLIP) combines dual-level intensity projection, multi-frequency fringe projection, and an iterative method for distortion compensation, to accurately achieve spatial separation of 3D objects of range of reflectance. MS-BLIP is demonstrated by dynamic 3D imaging of a translating engineered box and a rotating vase. With an FOV of up to 1.7 m×1.1 m and a working distance of up to 2.8 m, MS-BLIP is applied to capturing full human-body movements at video rate.

The scope of the claims should not be limited by the embodiments set forth in the examples but should be given the broadest interpretation consistent with the description as a whole.

1. A system for 3D surface imaging of a 3D object, comprising:
a light source;
a digital micromirror device;
a band-limited 4f imaging system;
a dove prism;
a camera lens; and
a high-speed camera;
wherein a light beam generated by the light source is directed to the digital micromirror device, the digital micromirror device displays binary fringe patterns, the band-limited 4f imaging system converts the binary fringe patterns to grayscale fringe patterns at an intermediate image plane; the dove prism rotates the grayscale fringe patterns onto the intermediate image plane to match an aspect ratio of the object, the camera lens projects the greyscale fringe patterns from the intermediate image plane to the object, and the high-speed camera captures deformed structure images reflected by the object;
the captured images being transferred to a computer connected to a frame grabber.

2. The system of claim 1, wherein the light source is a pulsed laser.

3. The system of claim 1, wherein the light source is a nanosecond pulsed laser.

4. The system of claim 1, wherein the digital micromirror device is selected with a display rate in a range between 500 Hz and 1 kHz.

5. The system of claim 1, wherein the band-limited 4f imaging system comprises a first lens, a second lens and a pinhole positioned between the first and the second lenses; and the dove prism is placed between the second lens and the intermediate image plane.

6. The system of claim 1, wherein the camera lens is selected with a focal length of at most 20 mm, a working distance of at most 1.5 m, and a view angle in a range between 70° and 109°.

7. The system of claim 1, wherein the high-speed camera is selected with a frame rate of at least 1 kHz with an image resolution of at least 1.1 M pixels.

8. The system of claim 1, wherein the high-speed camera is a CMOS camera.

9. The system of claim 1, wherein the captured images are synchronized by a trigger signal of the digital micromirror device.

10. A method for 3D surface imaging of a 3D object, comprising:
directing a light beam to a digital micromirror device, the digital micromirror device displaying binary fringe patterns, converting the binary fringe patterns to grayscale fringe patterns at an intermediate image plane; rotating the grayscale fringe patterns onto the intermediate image plane to match an aspect ratio of the object, projecting the greyscale fringe patterns from the intermediate image plane to the object, capturing deformed structure images reflected by the object by a high-speed camera; and transferring the captured images to a computer connected to a frame grabber.

11. The method of claim 10, wherein comprising selecting two normalized intensity levels for each fringe pattern and for any camera pixel in the deformed structure images, if a value in a sequence of high-intensity projection is saturated, replacing the value with a corresponding sequence with low intensity.

12. The method of claim 10, comprising projecting multiple sets of fringe patterns with different periods to the object, and unwrapping a phase value of each pixel independently.

13. The method of claim 10, comprising determining distortion coefficients from calibration of the high-speed camera and of a projector comprising a light source generating the light beam directed to the digital micromirror device, the digital micromirror device, a band-limited 4f imaging system converting the binary fringe patterns to grayscale fringe patterns at the intermediate image plane, the intermediate imaging plane and a camera lens projecting the greyscale fringe patterns from the intermediate image plane to the object; and iteratively analyzing undistorted pixels of the high-speed camera and of the projector to recover distortion-compensated 3D information.

14. The method of claim 10, comprising selecting a pulsed laser as the light beam directed to the digital micromirror device.

16. The method of claim 10, comprising selecting a digital micromirror device with a display rate of in a range between 500 Hz and 1 kHz.

17. The method of claim 10, comprising using a band-limited 4f imaging system comprising a first lens, a second lens and a pinhole positioned between the first and the second lenses convert the binary fringe patterns to grayscale fringe patterns at intermediate image plane; and a dove prism placed between the second lens and the intermediate image plane to rotate the grayscale fringe patterns onto the intermediate image plane to match the aspect ratio of the object

18. The method of claim 10, comprising selecting a camera lens with a focal length of at most 20 mm, a working distance of at most 1.5 m, and a view angle in a range between 70° and 109°, and using the camera lens to project the greyscale fringe patterns from the intermediate image plane to the object.

19. The method of claim 10, comprising selecting the high-speed camera with a frame rate of at least 1 kHz with an image resolution of at least 1.1 M pixels.

20. The method of claim 10, comprising selecting at least one of: multiple cameras, a display rate of the digital micromirror device, and a power of the light source generating the light beam directed to the digital micromirror device, according to a target imaging speed.
